(19) United States
(12) Patent Application Publication
(10) Pub. No.: US 2005/0166417 A1
(43) Pub. Date: Aug. 4, 2005

(54) Tape measure with inside measure indicators

(76) Inventor: Edward O. Clapper, Tempe, AZ (US)

Correspondence Address: RICHARD C. CALDERWOOD, 2775 NW 126TH AVE, PORTLAND, OR, 97229-8381, US

(21) Appl. No.: 10/768,414

(22) Filed: Jan. 29, 2004

(51) Int. Cl. G01B 3/10

(52) U.S. Cl. 33/759

(57) ABSTRACT

A retractable tape measure wherein the tape is adapted with a set of inside measure distance indicators which factor in the longitudinal external dimension of the housing. The user can take a direct inside measure reading from the tape, without having to add in the dimension of the housing. The housing can be any desired size, without regard for whether its length is an easy-to-add number such as an integer. The tape may have separate marks and distance indicators for inside measurements than for outside measurements.

### BACKGROUND OF THE INVENTION

1.Technical Field of the Invention

This invention relates generally to apparatus for measuring distance, and more specifically to a tape measure coiled in a housing and including markings for performing inside measurements with the tape and the housing.

2. Background Art

FIG. 1 shows a conventional tape measure 10 including a housing 12 and a tape 14. Ordinarily, the tape is formed of spring steel or the like, and is retracted into a coiled configuration within the housing under tension of a retraction spring (not shown).

The term “distal” refers to the end of the tape which is farthest from the housing, i.e. the zero distance position, and the term “proximal” refers to locations away from the distal end and toward the housing of the tape measure. The term “longitudinal” refers to distances or measurements lengthwise along the tape.

The tape typically includes an L-shaped end piece 16 which is slideably fastened near the distal end 18 of the tape by rivets 20. Distance marks 22 are placed at very carefully determined locations along the tape to denote e.g. quarter-inch increments (the longer marks) and sixteenth-inch increments (the shorter marks). Distance identifiers 24 are placed at appropriate locations along the tape, indicating how far from the end piece the various distance marks are. Typically, only a subset of the distance marks have corresponding distance identifiers, as the user is readily able to determine the distance of any interstitial distance mark is, from the surrounding distance identifiers.

Although FIG. 1 illustrates only a single set of distance identifiers, often, two sets of distance identifiers are provided: (A) one which indicates the total number of inches from the distal end of the tape to the corresponding mark, and (B) another which indicates both the number of feet and the number of inches modulo 12 or, in other words, the number of inches beyond the previous foot indicator. Thus, the same distance mark may be provided with e.g. (A) a distance identifier of 69 inches, and (B) a distance identifier of 9 inches (located 9 inches after a distance identifier at 5 feet).

FIG. 2 illustrates the end piece 16 slideably mounted to the tape 14 by rivets 20. The central shaft of the rivet is solidly coupled to the end piece by virtue of the hole through the end piece having the same diameter as the central shaft of the rivet. The hole 26 through the tape, however, has a greater longitudinal dimension, giving the end piece a predetermined amount of longitudinal slop or slide.

FIG. 3 illustrates the tape measure 10 being used to make an outside measurement on an object such as a window frame 30. The window frame includes an outside surface 32 which is being measured. The measurement is being taken from the end of that outside surface, where it meets a perpendicular outside surface 34. The end piece 16 of the tape is hooked over this edge, and the housing 12 is drawn away, extending the tape 14 until the position being measured has exposed tape positioned adjacent to it, where the distance marks 22 and the distance indicators 24 can be read.

When the end piece is engaged over the edge and the tape is pulled tight, the tape will slide until the holes 26 engage the distal side of the rivets, leaving the extra dimension of the holes showing on the proximal side of the rivets, as shown.

By hooking the L-shaped end piece over the edge of the object being outside measured, a single user can make repeated, accurate measurements, and do so at distances farther from the end of the object than he could easily reach.

FIGS. 4-6 illustrate the tape measure 10 being used for taking an inside measure of a bottom portion 38 window frame 30. The back side 40 of the housing 12 is placed against the inside of the right window frame 42, and the tape 14 is extended until the end piece 16 not only contacts the inside of the left window frame 44, but further until the rivets 20 engage the proximal ends of the holes 26 through the tape. The amount by which the longitudinal dimension of the holes exceeds the diameter of the rivets, or, in other words, the amount of slop in the end piece mounting, should ideally be the same distance as the thickness of the perpendicular portion 28 of the end piece, whereby the proximal face of the perpendicular portion 28 in an outside measurement and the distal face of the perpendicular portion in an inside measurement are coplanar with respect to the distance marks on the tape.

According to the prior art, in order to calculate the inside measure, the user must add the distance indicated at the distal edge 46 of the housing, plus the longitudinal dimension of the housing itself, which is typically although not always labeled 48 on the outside of the housing. This is an unnecessary requirement, and offers the opportunity for errors to occur. In order to reduce the likelihood of such errors, the manufacturer may be forced into using a housing with a relatively easy to add external longitudinal dimension, such as 3.000 (exactly three) inches.

What is needed, then, is an improved tape measure which facilitates inside measurements without forcing the user to perform complicated arithmetic which typically includes difficult fractions with different denominators, which are difficult for the layman to handle correctly, and without forcing the manufacturer to compromise away from an ideally sized housing to one with a convenient-to-add external dimension.

### BRIEF DESCRIPTION OF THE DRAWINGS

FIGS. 1 and 2 show a conventional tape measure according to the prior art, with its end piece in an extended position such as is used in performing outside measurements.

FIG. 3 shows the conventional tape measure performing an outside measurement.

FIGS. 4 and 5 show the conventional tape measure, with its end piece in a retracted position such as is used in performing inside measurements.

FIG. 6 shows the conventional tape measure performing an inside measurement.

FIG. 7 shows one embodiment of a tape measure according to this invention, adapted solely for making inside measurements.

FIG. 8 shows another embodiment of a tape measure according to this invention, adapted for making both outside and inside measurements.

FIG. 9 shows another embodiment of a tape measure according to this invention, wherein the tape includes a first set of distance marks used in outside measurements and a second set of distance marks used in inside measurements, and having a rigidly mounted end piece.

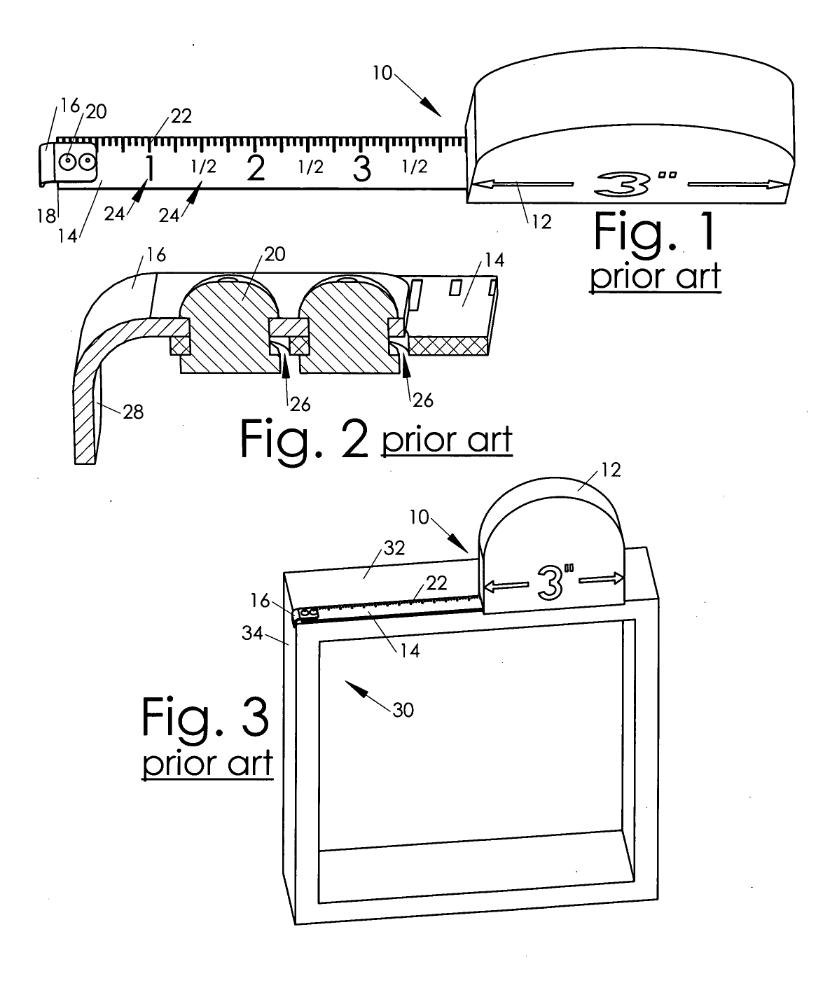

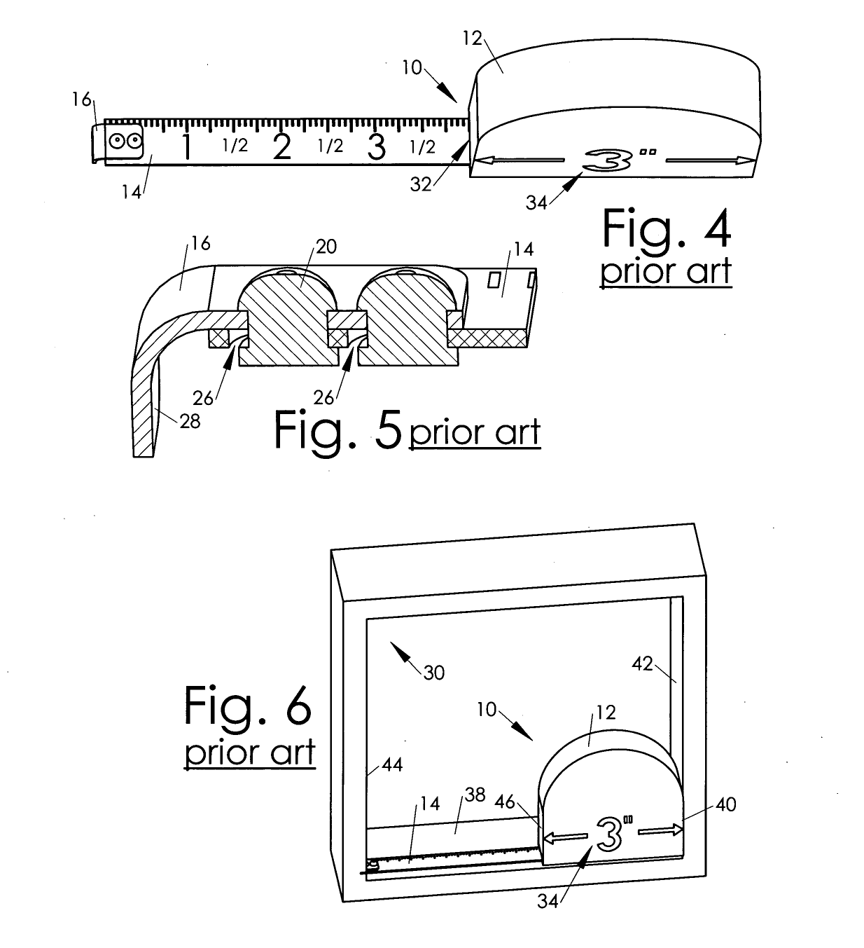

### DETAILED DESCRIPTION

The invention will be understood more fully from the detailed description given below and from the accompanying drawings of embodiments of the invention which, however, should not be taken to limit the invention to the specific embodiments described, but are for explanation and understanding only.

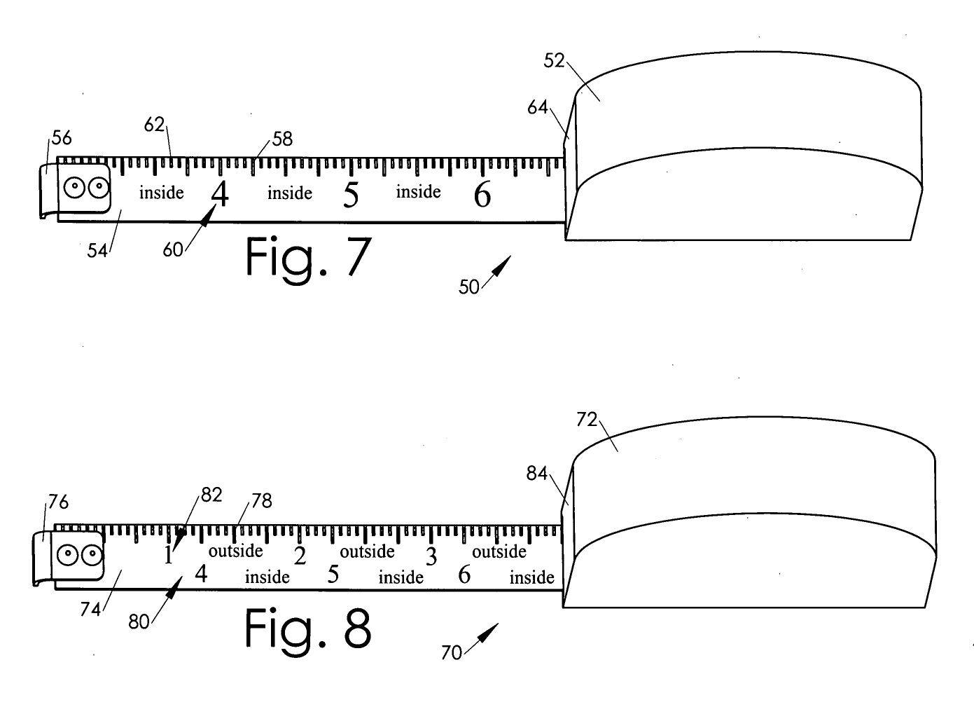

FIG. 7 illustrates one embodiment of a tape measure 50 according to this invention. The tape measure includes a housing 52 and a tape 54 and, optionally, an end piece 56.

The tape includes at least one set of distance marks 58 and a set of inside measure distance indicators 60. The inside distance indicators are positioned such that they take into account the longitudinal dimension of the housing. In the example shown, the housing is 2.625 inches long (but note that it is not strictly necessary for the user to know this), and the tape measure is shown as measuring an inside distance of 6.75 inches.

On a conventional tape, the distance indicators are set with 0 at the end of the tape, and the first, most distal distance indicator is typically 1 inch, which would be at the distance mark identified as 62. Because the distance indicators 60 inherently include the longitudinal dimension of the housing, the first, most distal distance indicator is, in this case, the 4 inch indicator. The housing is 2.625 inches long, so the numbering at the end of the tape effectively begins at 2.625 rather than at 0. The 3 inch mark is covered by the end piece, so the first visible distance indicator is the 4 inch indicator.

To make an inside measurement, the user simply needs to determine the distance indicated by the marks and indicators at the distal edge 64 of the housing, and does not need to add in any value for the length of the housing. The length of the housing, whatever it happens to be, has been built into the distance indicators themselves.

FIG. 8 illustrates another embodiment of a tape measure 70 including a housing 72, a tape 74 and, optionally, an end piece 76. The tape includes at least a first set of distance marks 78 and a set of inside measure distance indicators 80. The tape further includes a set of outside measure distance indicators 82 which do not account for the size of the housing, as they are for taking outside measurements.

In some embodiments, the inside and outside measure distance indicators may have their own respective sets of distance marks. This may be desirable if, for example, the end piece is rigidly mounted. In the embodiment shown, the housing has a longitudinal dimension of 2.75 inches. If a single set of distance marks is used, it is desirable that the inside and outside distance indicators fall on “major” distance marks (the longer ones). In such embodiments, the simplest way to accomplish this is to manufacture the housing with a longitudinal dimension which is an integer multiple of the distance between major distance marks; in the embodiment shown, the 2.75-inch housing is an integer multiple of the 0.25 inch between major marks. In the particular instance illustrated, this enables the inside measurement 5-inch indicator to fall on the long distance mark which corresponds to a 2.25-inch outside measurement.

It should be noted that, previously, the housing had to have an external longitudinal dimension which was easy for users to add into inside measurements, such as an even three inches. This invention frees the designer from the requirement, enabling the use of any size housing whatsoever. The housing can be sized, within the bounds of the major mark requirement, for its own optimal performance, without regard to whether its outside measurement is an easy-to-add dimension such as an integer number of whole inches.

To take an outside measurement, the tape measure is used as though it were a conventional tape measure, and the outside measurement distance indicators are read. To take an inside measurement, the inside measurement distance indicators are read at the distal face 84 of the housing.

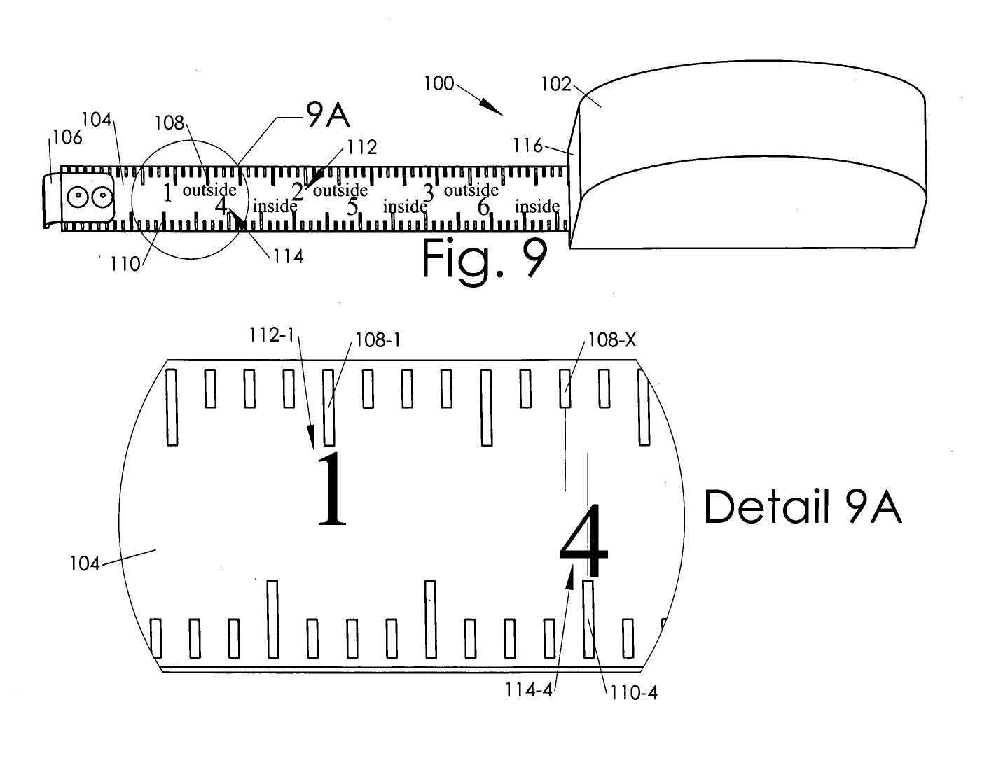

FIG. 9 illustrates another embodiment of a tape measure 100 which includes a housing 102 of arbitrary size and a tape 104. The tape includes an end piece 106 which is rigidly mounted, rather than slideably as explained above. The tape includes separate outside distance marks 108 and inside distance marks 110. Because the end piece is rigidly mounted to the tape, the outside and inside distance marks will be offset slightly, beyond any offset which accounts for the size of the housing. This extra offset accounts for the thickness of the end piece. (Such extra offset can also be used to compensate for any difference between the end piece thickness and the amount of slop in its mounting, such that those are not required to be identical.) In the example illustrated, the housing is 2.625 inches long. This would be a very awkward housing size if used in a conventional tape measure, because it presents the user with inconvenient arithmetic in inside measurements. However, the outside distance marks and outside distance indicators 112, and inside distance marks and inside distance indicators 114 make the size of the housing irrelevant to the user, even when taking inside measurements. The user simply takes his reading at the distal edge 1 16 of the housing, and the inside distance marks and indicators compensate for whatever the size of the housing happens to be. If the manufacturer offers two or more tape measures with different size housings, they will need to be provided with different tapes having their inside marks and distances suitably adjusted, but that is not the user's concern.

Detail view 9A illustrates a short section of the tape 104 in greater detail, specifically illustrating the offset between the respective inside and outside marks and indicators which compensates for the size of the housing. The first visible outside measurement distance indicator is the one inch indicator 112-1, and it is placed at the one inch outside measurement distance mark 108-1. The first visible inside measurement distance indicator is the four-inch indicator 114-4, and it is placed at the four-inch outside measurement distance mark 110-4. Because the housing is 2.625 inches long, the four inch inside mark 106-4 is roughly 0.375 inch more proximal than the one inch outside mark 104-1 (the magnitude of the outside indicators themselves compensate for the whole integer gradation, so the inside marks are placed at “modulo one inch” offsets). In other words, the 0.625 non-integer portion of the 2.625-inch size of the housing causes the distance mark 110-4 to move from a position even with the mark 108-1 to a position even with the mark 108-X. The thickness and mounting fashion of the end piece dictate finer positioning requirements. In the example shown, the end piece is rigidly mounted and has a thickness of 0.03125 inch. Therefore, the inside distance marks are moved 0.03125 inch more proximal, closer to the housing. This causes the distance mark 110-4 to move from a position even with the mark 104-X to the position at which it is shown in the drawing. The integer portion of the size of the housing determines the magnitude of the distance indicator 114-4 which is adjacent this distance mark 110-4.

In other embodiments, the inside and outside measurement marks and indicators could be located on opposite sides of the tape. In such embodiments, it may be helpful to provide the housing with a conventional locking mechanism for securing the tape in a fixed position, to avoid having the tape move between taking and reading the measurement.

Regardless of the present invention being far easier to use than the prior art tape measures, the manufacturer may still find it prudent to provide the tape and/or the housing with a variety of explanatory messages or graphics. For example, the housing could include an indication reminding the user that “INSIDE measures on the tape include this distance” and e.g. an arrow extending the length of the housing.

### Conclusion

When one component is said to be “adjacent” another component, it should not be interpreted to mean that there is absolutely nothing between the two components, only that they are in the order indicated.

The various features illustrated in the figures may be combined in many ways, and should not be interpreted as though limited to the specific embodiments in which they were explained and shown.

While the invention has been illustrated with respect to imperial units (inches), it could just as easily be used with any other type of length units such as centimeters, cubits, or hands. It could also be used with a tape having two or more measurement units. While the various sets of distance marks and indicators have been illustrated as being on the same side of the tape, in other embodiments the respective sets could be on opposite sides of the tape; for example, the top side could be marked for outside measurements, and the bottom side could be marked for inside measurements. In such embodiments, it will be helpful if the housing is provided with a tape-locking mechanism as is known in the art, so the user can preserve the measurement in a fixed position while turning the tape over.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

1. An apparatus comprising;
a housing having a distal edge and a proximal edge and a longitudinal exterior dimension from the distal edge to the proximal edge; and
a exactly one tape retractably coilable within the housing and extending from the distal edge of the housing, wherein the tape includes,
a distal end,
a first set of distance marks functionally identifying positions relative to the distal end, and
a set of inside measure distance indicators cach for indicating a distance from the distal end of the tape to a corresponding distance mark plus the longitudinal exterior dimension of the housing,
whereby the apparatus may be employed to perform an inside measurement whose value is indicated by the tape.

2. The apparatus of claim 1 wherein the tape further includes:
a set of outside measure distance indicators each for indicating a distance from the distal end of the tape to a corresponding distance mark;
whereby the apparatus may he employed to perform all outside measurement whose value is indicated by the tape.

3. The apparatus of claim 1 wherein:
the first set of distance marks includes major marks and minor marks; and
the longitudinal exterior dimension of the housing is a whole multiple of a distance between adjacent major marks.

4. The apparatus of claim 1 further comprising:
an end piece coupled to the tape.

5. The apparatus of claim 4 wherein:
the end piece is coupled to the tape so as to have a predetermined distance of longitudinal slop;
whereby the end piece can be used in making outside measurements and inside measurements.

6. The apparatus of claim 4 wherein:
the end piece is rigidly coupled to the tape and includes a portion which is perpendicular to the tape for hooking over an end of an object to be outside measured; and
the tape further includes a second set of distance marks functionally identifying positions relative to the a proximal face of the perpendicular portion of the end piece.

7. The apparatus of claim 6 wherein the tape further includes:
a set of outside distance indicators cach for indicating a distance from the perpendicular portion of the end piece to a corresponding outside distance indicator.

8. The apparatus of claim 1 wherein:
the first set of distance marks includes major marks and minor marks; and
the longitudinal dimension of the housing is not an integer multiple of a distance between adjacent major marks.

9. An improvement in a tape measure, the tape measure including a housing having a longitudinal dimension from a distal edge to a proximal edge, and a exactly one retractable tape having a distal end and bearing distance marks and distance indicators, wherein the improvement comprises:
the distance indicators providing measurements from the distal end of the tape to the proximal edge of the housing;
whereby inside measurements may be directly made with the improved tape measure without a user having add in the distance of the longitudinal dimension.

10. The improvement of claim 9 in the tape measure, wherein the improvement further comprises:
separate distance marks and distance indicators for inside measurement and for outside measurement.

11. The improvement of claim 10 in the tape measure, wherein the improvement further comprises:
an end piece rigidly coupled to the tape and including a perpendicular section; and
the inside measurement distance marks being offset along the tape from the outside measurement distance marks by a distance corresponding to a thickness of the perpendicular portion of the and piece.

12. The improvement of claim 9 in the tape measure, wherein the improvement further comprises:
an end piece slideably coupled to the tape;
the distance marks including major marks and minor marks;
the distance indicators comprising outside measurement distance indicators and inside measurement distance indicators; and
the longitudinal dimension of the housing is an integer multiple of a distance between adjacent major marks;
whereby the outside distance indicators and the inside distance indicators are enabled to share the same sot of distance marks.
